(19) United States
(12) Patent Application Publication
(10) Pub. No.: US 2007/0039896 A1
(43) Pub. Date: Feb. 22, 2007

(54) Oil cleaning system and method

(76) Inventors: Robert William Bowden, Katy, TX (US); Gene Bruce Moss, Katy, TX (US); Vatsal Mukundlal Shah, Sugar Land, TX (US); Jerry Edward Teltschick, Houston, TX (US)

Correspondence Address: SHELL OIL COMPANY, P O BOX 2463, HOUSTON, TX, 772522463, US

(21) Appl. No.: 11/438,652

(22) Filed: May 22, 2006

Related U.S. Application Data
(60) Provisional application No. 60/684,007, filed on May 23, 2005.

(51) Int. Cl. C02F 1/32

(52) U.S. Cl. 210/748

(57) ABSTRACT

An oil cleaning system is provided that includes a source of oil that is substantially free of aqueous content. The system further includes an oil flow conduit that is in fluid communication with the oil source. The oil flow conduit is operable to draw a flow stream substantially free of aqueous content from the oil source. Further, a barrier filter is positioned in the conduit to filter particles from the flow stream. Furthermore, an electrostatic fluid cleaner is positioned in the oil flow conduit downstream of the barrier filter to remove contaminants from oil flow exiting the barrier filter, particularly insoluble, submicron particles of oil degradation products.

The present application claims the benefit of pending U.S. Provisional Patent Application Ser. No. 60/684,007 filed May 23, 2005, the entire disclosure of which is hereby incorporated by reference.

### FIELD OF THE INVENTION

The present invention relates generally to a fluid cleaning system and more particularly, to a system and method for cleaning oil flow. The system and method are particularly suited for removing contaminants from an industrial oil flow stream, and may employ one or more types of fluid cleaning devices and cleaning methods, including electrostatic fluid cleaning.

### BACKGROUND OF THE INVENTION

Industrial oils are commonly used in lubrication and hydraulic systems. Common industrial oils include hydraulic oils, turbine oils, compressor oils, gear oils, and circulating oils. It is generally known that a high percentage of failures experienced by machinery that incorporate one of these industrial oil systems is caused by a reduced performance or failure in the part of the industrial oil. In particular, the accelerated degradation of the oil and/or introduction of contaminants in the oil typically lead to such reduced performance and failures. Typical contaminants include water, metal wear particles, dust, fibers, and other debris. As the oil ages and oxidation occurs, oxidation byproducts become another source of contamination. These byproducts include tars, varnishes, sludge and like materials.

Filtration systems are often incorporated with these industrial oil systems and employed to filter contaminants from the oil. Filtration methods may employ mechanical or barrier filters to filter fine particles as low as one to three microns in size. For smaller, submicronic contaminants, mechanical filtration has proven to be significantly less effective in large commercial systems.

An alternative to mechanical filtration (i.e., the use of mechanical or barrier filters) is electrostatic oil cleaning (i.e., the use of electrostatic fluid filters). In an electrostatic oil cleaner, the oil is allowed to flow between electrodes with a high DC voltage across them. As the oil flows in between the charged electrodes, the submicronic particles are drawn towards the electrodes and, thereby, removed from the oil. A further discussion of electrostatic fluid cleaners may be found in U.S. Pat. No. 6,129,829.

### SUMMARY OF THE INVENTION

In one aspect of the present invention, an oil cleaning system is provided. The system includes a source of oil that is substantially free of aqueous content and an oil flow conduit that is in fluid communication with the oil source. The oil flow conduit is operable to draw a flow stream substantially free of aqueous content (e.g., less than about 500 ppm and more preferably) from the oil source. A barrier filter is positioned in the conduit to filter particles from the flow stream. Also, an electrostatic fluid cleaner is positioned in the oil flow conduit downstream of the barrier filter to remove contaminants from oil flow exiting the barrier filter. Preferably, the oil flow conduit is a re-circulating conduit having an inlet disposed in fluid communication with the oil source and a return conduit directed into the oil source. Further, the oil filter is preferably positioned immediately upstream and preceding the electrostatic cleaner.

In another aspect of the invention, a method is provided for removing contaminants, including insoluble, submicron particles of oil degradation products, from industrial oil that is substantially free of aqueous content. The method entails drawing an oil flow stream containing submicron particles including oil degradation products from the source of industrial oil. The oil flow stream is then passed through an oil flow conduit. This includes passing the flow stream through a barrier filter to filter particles from the flow stream. Then, the flow stream exiting the barrier filter is passed through an electrostatic fluid cleaner to remove insoluble, submicron particles from the flow stream, including the oil degradation products.

In further applications, the method includes positioning temperature sensor in the oil flow conduit upstream of the electrostatic fluid cleaner. The temperature sensor is configured to detect a predetermined temperature in the flow stream. Upon detection of the predetermined temperature, the sensor operates to divert the flow stream upstream of the electrostatic cleaner into a conduit bypassing the electrostatic cleaner.

### BRIEF DESCRIPTION OF THE DRAWINGS

The present invention may be best understood by way of example and in conjunction with the accompanying drawings, in which:

FIG. 1 is a simplified schematic of an oil cleaning system, according to the present invention; and

FIG. 2 is a simplified flow chart of an oil cleaning method, according to the present invention.

### DETAILED DESCRIPTION OF THE DRAWINGS

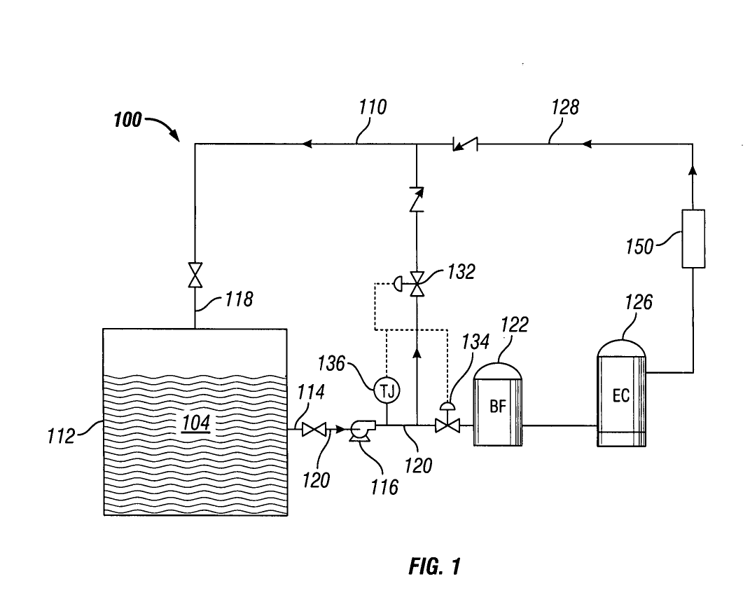

The present invention relates generally to a fluid cleaning system, and more particularly, a system and method for cleaning oil flow. The inventive system and method may be incorporated with or adjacent to an industrial oil system (e.g., hydraulic oil, turbine oil, etc.) so as to pass oil through one or more fluid cleaning devices and to remove target contaminants from the oil flow. FIG. 1 illustrates an oil cleaning system, particularly suited to “dry” industrial oil applications, in accordance with the present invention.

The present invention takes advantage of the capability of electrostatic oil cleaners to remove insoluble submicronic contaminants from oil flow. In one aspect of the invention, the system effectively combines electrostatic oil cleaning with mechanical filtration (i.e., the use of mechanical or barrier filters). Among other things, the use of mechanical filters can generate a pressure differential that is undesirable in many applications. The oil flow through a barrier filter can also generate friction and thus, can generate static electricity in the oil flow. The accumulation of static electricity can cause a spark discharge at the outlet of the barrier filter or in the body of the fluid as the fluid finds an appropriate grounding location. Furthermore, at a temperature of several thousand degrees, the spark discharge quickly degrades the oil that it contacts. The present inventive system and method addresses these concerns, in one respect, by maintaining a relatively low oil flow rate (as further defined below). The present inventive system and method also controls the aqueous content in the oil flow.

As used herein, the term “contaminants” shall refer to target particles, material, byproducts, and the like which are undesirable and thus removed from the industrial oil flow (according to the present method). Furthermore, the terms “removing contaminants” shall refer to a process of removing these “contaminants” from oil flow by way of filtering, electrostatic oil cleaning, or other processes. Furthermore, as used herein, the term “aqueous content” shall refer to oils with both free water and/or dissolved water in oil.

It should first be noted, however, that the system and method illustrated herein and the accompanying description are provided for exemplary purposes only. It will become apparent to one skilled in the mechanical, chemical, or other relevant art, upon a reading of the present description and/or viewing of the accompanying drawings, that variations and modifications to the system and a method associated therewith may be made, without departing from the scope and spirit of the invention. Thus, the description of exemplary applications as provided herein should not be construed to limit the invention to the specific methods and structures described.

FIG. 1 provides a simplified illustration of an oil cleaning system, according to the present invention. The system 100 is particularly suited for cleaning “dry oils”, as further discussed below. The oil cleaning system 100 is shown having a re-circulating oil flow conduit 110 that draws an oil flow 120 from an oil flow reservoir 112. The re-circulating conduit 110 directs the oil flow 120 through a barrier filter 122 and an electrostatic cleaner 126, before returning a “cleaned” oil flow 128 into an inlet 118 of oil reservoir 112. The oil cleaning system 100 preferably employs a standard centrifugal, positive displacement, or other suitable pump 116 to draw the oil flow 120 from an inlet 114 connected to oil reservoir 112. In the oil cleaning system 100, the barrier filter 122 is positioned upstream of and immediately preceding (uninterrupted by other fluid cleaning or fluid content altering devices) the electrostatic cleaner 126. In this way, filtered oil flow exiting the barrier filter 122 is immediately directed into the electrostatic cleaner 126 for further cleaning.

Furthermore, the re-circulating conduit 110 of system 100, may be provided with a bypass conduit 130. The bypass conduit 130 is fluidly connected to the re-circulating conduit 110 at a tee or intersection intermediate the series of fluid flow cleaning devices 122, 126 and the pump 116. Control valves 132, 134 are appropriately situated in the bypass conduit 130 and the re-circulating conduit 110, respectively, to direct the flow stream 120 in a predetermined manner. In alternative applications, a three-way valve may be employed in lieu of multiple valves. In the normal operation, the oil flow 120 is directed through the open control valve 134 and through the fluid flow cleaning devices 122, 124, 126. In the normal operation, the control valve 132 upstream of the fluid flow cleaning devices 122, 126 is set in the closed position.

A control mechanism is provided on the re-circulating conduit 110 and in communication with the oil flow 120 discharged from the pump 116. Specifically, a temperature sensor 136 may be positioned between the reservoir 112 and the fluid flow cleaning devices 122, 126 as shown in FIG. 1, thereby monitoring the temperature of the oil flow 120 discharged from the pump 116. The temperature sensor 136 may be set to send a signal or otherwise activate upon detection of a predetermined temperature (i.e., a high temperature) in the oil flow 120. The temperature sensor 136 is shown operatively associated with the control valves 132, 134, and more particularly, actuators for the valves 132, 134. Thus, upon detection of the predetermined temperature of the oil flow 120, the temperature sensor 136 activates control valve 134 and valve 134 is moved to the closed position. Prior to this actuation or simultaneously therewith, the control valve 132 is actuated and moved to the open position. Accordingly, oil flow 120 is diverted into bypass conduit 130 and returned to the oil reservoir 112, without cleaning.

In many applications, the temperature of the oil flow in the oil reservoir will gradually reduce and stabilize. For example, a temperature increase may have been caused by a spike or other irregularity in the relevant machinery or system (e.g., oil cooling system). In one embodiment, a preferred temperature sensor 136 is set at about 140° F. (60° C.). Such a setting is intended to protect elements of the electrostatic cleaner and the barrier and water filters from the effects of high temperature. Specifically, this temperature setting protects seals and other components found in the cleaning system. One suitable type of temperature is a thermocouple mounted on the oil flow conduit 110.

The barrier filter 122 may be any one of various commercially available and suitable mechanical type filters. The barrier filter 122 includes a filter media selected to remove target contaminant-particles in the oil flow and enhance the performance or longevity of the electrostatic fluid cleaner 126.

The arrangement of fluid cleaning devices effects a specific oil cleaning process utilizing the barrier filter 122 and the electrostatic fluid cleaner 126. The barrier filter 122 functions to remove larger sized particles which would otherwise shorten the useable life of the electrostatic cleaner 126. Preferably, the oil filtering system 100 utilizes a filter media in the barrier filter 122 having a rating between about 5.0 to 10.0 microns, and more preferably, between about 0.5 to 1.0 microns. Moreover, it is preferred that the pump 116 passes oil flow through the filter 122 (and the electrostatic oil cleaner 126) at a flow rate less than about 45.42 liters/min (12.0 gpm), more preferably, less than about 22.7 liters/min (6.0 gpm) and, most preferably, between about 5.68 to 20.82 liters/min (1.5 to 5.5 gpm). As mentioned above, such a low flow rate and resulting reduced flow velocities enhances the performance of the electrostatic oil cleaner and minimizes the potential for the generation of static electricity. A lower flow results in a reduction of pressure loss through the oil flow conduit 110.

After mechanical filtration, the filtered oil flow is passed to the electrostatic fluid cleaner 126. Employment of an electrostatic cleaning process allows for the removal of contaminants of all or most sizes from the flow stream, including insoluble contaminants. In particular, the electrostatic fluid cleaner is adapted to remove insoluble, submicron contaminants, which are not removed by mechanical filtration.

The oil cleaning system 100 is particularly suited for use with “dry”, industrial oil, such as some industrial oils used with gas turbine systems and operated under conditions required by such systems. Such “dry” industrial oils are defined to be an oil that is substantially free of aqueous content such that the electrostatic cleaner is provided sufficient voltage to be effective (i.e., at least less than 500 ppm). More preferably, the oil drawn will have less than 50 ppm aqueous content.

The oil cleaning system 100 is also particularly suited in applications wherein the industrial oil is used in conjunction with a plurality of servo valves and directional valves (e.g., hydraulic control systems). In these applications, degradation products in the submicron range (e.g., less than one micron) have the ability to escape the traditional or conventional filtering processes. These degradation products can collect on the surfaces of the servo valves and directional valves, thereby generating a tar or varnish on the surfaces. This varnish as well as additional particles that may stick to it is a primary cause for servo valves to malfunction or, more particularly, to “stick”. As a result, the hydraulic control system fails to operate in the expected or normal manner.

As a formulated oil (e.g., engine oils and most industrial oils) is used, it ages and oxidizes to form degradation products. Typically, the base oil is a mineral oil that is derived from refining of crude oil and generates oxidation products which are insoluble in the oil. The additives are also consumed and form their own degradation products. Referred to herein collectively as “oil degradation products,” these contaminants are insoluble in the oil and contribute to the varnish and sludge that is generated by the aged oil. In one aspect of the present invention, the system and method are particularly suited for removing these oil degradation products from the oil. In particular, the electrostatic fluid cleaner is adapted and positioned to remove insoluble, submicron contaminants exiting the barrier filter. These contaminants include the oil degradation products. Accordingly, the cleaned oil exiting the electrostsatic fluid cleaner is free or is nearly free of oil degradation products. Accordingly, the potential for the generation of varnish and other material on the servo valves and directional valves of the hydraulic control system or other parts of the operating system is reduced, thereby enhancing the life and the performance of the system.

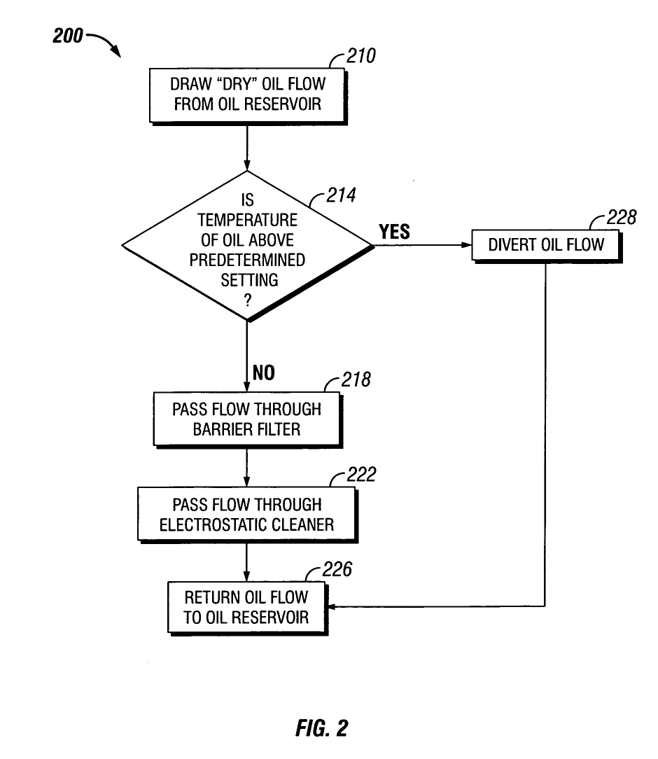

FIG. 2 provides a simplified representation of the cleaning method according to the invention. This representation is provided for exemplary purposes and, therefore, should not be construed to limit the invention to the specific steps illustrated.

The inventive method provides an advantageous method of removing target contaminants from an oil flow that is substantially free of aqueous content (i.e., less than about 500 ppm). First, the oil flow is drawn (step 210) from an oil source such as an oil reservoir. In further applications, the oil source may be a main fluid system, as opposed to a static reservoir. In yet further applications, the oil cleaning system according to the invention may be incorporated “in-line” with the main fluid system. In this latter embodiment, the oil source is the main fluid system itself.

In the embodiment discussed previously and in respect to FIG. 1, the method employs a re-circulating conduit from and to the oil reservoir. In a subsequent step, the drawn oil is monitored for a predetermined temperature (step 214). If the detected temperature meets or exceeds the predetermined temperature, the oil flow is diverted (step 228) into a bypass conduit. Typically, the bypass conduit will discharge the diverted oil flow back to the oil reservoir. In this way, relatively high temperature oil (which may be common in certain gas turbine applications in summer months) is diverted away from the electrostatic fluid cleaner.

If the detected temperature is below the predetermined setting, the oil flow is passed through a barrier filter (step 218). The barrier filter removes certain particles from the oil flow (generally, the relatively larger particles which are larger than the submicron-sized particles). Preferably, the flow stream is maintained below about 45.42 liters/min (12.0 gpm) (and more preferably, less than about 22.7 liters/min (6.0 gpm) and most preferably, between about 5.68 to 20.82 liters/min (1.5 to 5.5 gpm)). At this relatively low rate, the potential for static electricity generation is minimized. Furthermore, the potential for a build-up of charge in the barrier filter is minimized. By specifying an appropriate flow rate(s) at which the oil flow may be pumped through the barrier filter, the inventive method provides one of the conditions for practical and effective use of the combination of barrier filter and electrostatic fluid filter.

Thereafter, the filtered oil flow exiting the barrier filter is passed through an electrostatic fluid cleaner. It is noted that the oil flow, at this point, is substantially free of larger contaminant particles. As a result, the cleaning process effected by the electrostatic cleaner is generally enhanced. More specifically, the electrostatic cleaner is more effective in removing insoluble, submicron material from the oil flow, including the oil degradation products. The resultant cleaner oil flow may be passed through a particle monitor or equivalent, to check the effectiveness and efficiency of the cleaning process. After the particle monitor, the oil flow, which is substantially free of insoluble submicron particles, including oil degradation product and water contaminants, is returned to the oil reservoir (step 226).

The many features and advantages of the present invention are apparent from the Detailed Description, and thus, it is intended by the appended claims to cover all such features and advantages of the invention which fall within the true spirit and scope of the invention. Further, since numerous modifications and variations will readily occur to those skilled in the relevant mechanical, chemical and other relevant art, it is not desired to limit the invention to the exact structures and operations illustrated and described herein. For example, various arrangements of the components of the oil filtering system described above, and/or the inclusion or absence of one or more of the described components may be employed and will readily be apparent to one skilled in the art (upon a reading and/or viewing of the present disclosure). Thus, the invention encompasses all different versions that fall literally or equivalently within the scope of the appended claims.

What is claimed is:

1. An oil cleaning system comprising:
a source of oil that is substantially free of aqueous content;
an oil flow conduit in fluid communication with said oil source and operable to draw a flow stream substantially free of aqueous content therefrom;
a barrier filter positioned in said conduit to filter particles from said flow stream; and
an electrostatic fluid cleaner positioned in said oil flow conduit downstream of said barrier filter to remove contaminants from oil flow exiting said barrier filter.

2. The system of claim 1, wherein said oil flow conduit is a re-circulating conduit having an inlet disposed in fluid communication with said oil source and a return conduit directed into said oil source.

3. The system of claim 1, wherein said barrier filter includes a filter media having a pore size with a filter rating of at least 1 micron.

4. The system of claim 1, wherein said oil source includes insoluble, submicron particles and wherein said electrostatic fluid cleaner is positioned to remove the insoluble submicron particles from said flow stream.

5. The system of claim 4, wherein said oil source includes submicron particles of oil degradation products, said electrostatic fluid cleaner being positioned to remove said oil degradation products from said flow stream.

6. The system of claim 1, wherein said oil source includes oil having an aqueous content of less than about 500 ppm.

7. The system of claim 1, wherein said barrier filter is positioned immediately preceding said electrostatic fluid cleaner.

8. The system of claim 1, further comprising:
a selectively operable bypass conduit fluidly connected with said oil flow conduit upstream of said electrostatic fluid cleaner; and
a temperature sensor operatively associated with said bypass conduit and positioned to detect a predetermined oil flow temperature in said flow stream upstream of said electrostatic fluid cleaner, said sensor being operable with said bypass conduit to divert flow in said flow stream through said bypass conduit upon detection of the predetermined oil flow temperature.

9. A method of removing contaminants, including insoluble, submicron particles of oil degradation products, from industrial oil substantially free of aqueous content, said method comprising the steps of:
drawing an oil flow stream containing submicron particles of oil degradation products, from a source of industrial oil substantially free of aqueous content;
passing the oil flow stream through an oil flow conduit, including passing the flow stream through a barrier filter to filter particles from the flow stream; and
passing the flow stream exiting the barrier filter through an electrostatic fluid cleaner to remove insoluble, submicron particles from the flow stream, including the oil degradation products.

10. The method of claim 9, wherein said drawing steps include drawing and passing the flow stream at a flow rate less than about 22.71 liters/min.

11. The method of claim 9, wherein said step of passing the flow stream through the barrier filter includes filtering particles about 5 micron and larger.

12. The method of claim 11, wherein said step of passing the flow stream through the barrier filter includes filtering particles about 0.5 micron and larger.

13. The method of claim 9, wherein the oil flow conduit is a re-circulating conduit fluidly connected with the oil source at an inlet and a return conduit, said method further comprising the step of returning cleaned oil flow exiting the electrostatic fluid cleaner into the oil source.

14. The method of claim 9, wherein said drawing step includes drawing the flow stream from an oil reservoir and said returning step includes returning a cleaned oil flow stream into the oil reservoir.

15. A method of claim 9, further comprising the step of positioning the barrier filter immediately upstream of and preceding the electrostatic cleaner.

16. The method of claim 12, further comprising the steps of:
positioning a temperature sensor in the oil flow conduit upstream of the electrostatic fluid cleaner, wherein the temperature sensor is configured to detect a predetermined temperature in the flow stream; and
upon detection of the predetermined temperature in the flow stream, operating the sensor to divert the flow stream upstream of the electrostatic fluid cleaner into a conduit bypassing the electrostatic fluid cleaner.

17. A method of removing contaminants, including insoluble, submicron particles of oil degradation products, from an industrial oil substantially free of aqueous content, said method comprising the steps of:
drawing an oil flow stream from an oil reservoir containing oil having submicron particles of oil degradation products therein, wherein the industrial oil is substantially free of aqueous content;
passing the oil flow stream through an oil flow conduit, including passing the flow stream through the barrier filter to filter particles from the flow stream;
passing the flow stream exiting the barrier filter through an electrostatic fluid cleaner to remove the oil degradation products therefrom; and
returning an oil flow stream exiting the electrostatic filter into the oil reservoir.

18. The method of claim 17, further comprising the steps of:
positioning a temperature sensor in the oil flow conduit upstream of the electrostatic fluid cleaner, wherein the temperature sensor is configured to detect a predetermined temperature in the flow stream; and
upon detection of the predetermined temperature in the flow stream, operating the sensor to divert the flow stream upstream of the electrostatic cleaner into a conduit bypassing the electrostatic fluid cleaner.

19. The method of claim 17, wherein said drawing step includes drawing and passing the flow stream at a flow rate less than about 22.71 liters/min.

20. The method of claim 17, wherein said step of passing the flow stream through the barrier filter includes filtering particles about 5 micron or larger from the flow stream.

21. The method of claim 17, wherein said step of passing the flow stream through the barrier filter includes filtering particles about 0.5 micron and larger from the flow stream.

22. The method of claim 17, wherein said step of drawing the flow stream includes drawing an oil flow stream having an aqueous content of less than about 500 ppm.

23. The method of claim 17, wherein said step of drawing the flow stream includes drawing an oil flow stream having an aqueous content of less than about 50 ppm.
